(19) United States
(12) Patent Application Publication
(10) Pub. No.: US 2012/0286508 A1
(43) Pub. Date: Nov. 15, 2012

(54) OFFSHORE SYSTEM FOR PRODUCING REGENERATIVE ENERGY

(76) Inventor: Alexander PODDEY, Vaihingen/Enz (DE)

(21) Appl. No.: 13/466,284

(22) Filed: May 8, 2012

(30) Foreign Application Priority Data
May 12, 2011 (DE) 10 2011 075 700.7

(51) Int. Cl. F03B 13/14

(52) U.S. Cl. 290/42

(57) ABSTRACT

An offshore system for producing regenerative energy, including a system of electrical water power energy converters, a system of wind energy plants, a system of hydrodynamically acting auxiliary elements, the hydrodynamically acting auxiliary elements being set up to influence, in a targeted manner, ocean waves and/or ocean currents with regard to their energy at the positions of the electrical water power energy converters and/or of the wind energy plants, in particular through interference.

### RELATED APPLICATION INFORMATION

The present application claims priority to and the benefit of German patent application no. 10 2011 075 700.7, which was filed in Germany on May 12, 2011, the disclosure of which is incorporated herein by reference.

### FIELD OF THE INVENTION

The present invention relates to an offshore system for producing regenerative energy, an “offshore system” being understood in the context of the present invention as a system that is situated in particular in open waters and is therefore exposed both to currents and to the action of waves. In particular, the present invention relates to an offshore system in which synergetic effects between energy extraction elements and energetically passive auxiliary elements having different principles of action are advantageously exploited.

### BACKGROUND INFORMATION

Offshore systems for producing regenerative energy have been known for some years, for example as so-called wind farms or wind parks, and are increasingly being built in order to harvest wind energy in a predetermined area, such as a region of the sea close to the coast, thus exploiting synergies that result from the spatially close situation of the individual wind energy plants of the wind park. This includes in particular short paths that are to be traveled during maintenance work on the individual plants, as well as reduced average length of the energy lines connecting the wind energy plants.

Another form of use of regenerative energy in the vicinity of the coast is offered by so-called wave power stations or current power stations. Regarding the situation of the individual instances of these power station farms or parks, the same advantages essentially hold as stated above in connection with wind power plants.

However, a disadvantage in the designs known from the existing art is that on the one hand excessively strong waves or currents can damage the existing energy producers, and on the other hand wave heights or current strengths that are too low have the result that the provided energy converters operate below their nominal output.

### SUMMARY OF THE PRESENT INVENTION

Therefore, an object of the exemplary embodiments and/or exemplary methods of the present invention is to reduce or prevent damage to energy converters provided in the sea (offshore), and to increase the utilization of capacity of the provided energy converters, so that the operational costs are more speedily amortized.

The exemplary embodiments and/or exemplary methods of the present invention may achieve the object named above through an offshore system having the features described herein. In the context of the exemplary embodiments and/or exemplary methods of the present invention, hydrodynamically acting auxiliary elements are understood as elements that have an influence on ocean currents and/or the swell, but do not themselves produce any electrical energy. However, it can be provided, with the aid of for example electrical energy, to adapt the characteristics of the hydrodynamically acting auxiliary elements to a particular operating situation, so that they have a different influence on the ocean current or the swell. This can include in particular a change of wave shape through which the height and/or frequency portions contained in the waves, as well as the current field prevailing under the surface, are modified. If in this way there takes place an increase or attenuation of the ocean current at the location of the water power energy converter, and/or an increase or attenuation of the average wave strength at the location of the water power energy converter, the hydrodynamically acting auxiliary element ensures, without providing energy input of its own, that higher electrical power levels can be produced in the water power energy converters, or elements of the offshore system are protected from excessive loading by water force.

The further descriptions herein indicate describe further developments of the exemplary embodiments and/or exemplary methods of the present invention.

According to an exemplary embodiment, the offshore system additionally has an adaptation device for receiving the electrical energy from the electric water power energy converters and wind energy plants. The adaptation device can be fashioned to convert the electrical energy produced by the water power energy converters or wind energy plants into a different form of energy, in order to bring about the collection of the produced energies and their common removal from the offshore system. The conversion can for example either be a frequency adaptation of electrical energy, or a conversion of the electrical energy into other forms of energy. For example, in a hydrolysis process, hydrogen and oxygen could be produced from seawater by the produced electrical energies, and both fluids could be removed from the offshore system in liquid form or gas form through a system of conduits. For this purpose, for example a pipeline can conduct the fluids to the nearby mainland. Alternatively, the adaptation device can for example include liquefaction devices in order for example to store the fluids in liquid form in storage devices contained in the offshore system. In order to enable economical efficiency ratings of the adaptation device, it is in particular advantageous to provide an adaptation device for each offshore system. Alternatively, each group of water power energy converters and/or wind energy plants can have a separate adaptation device.

The electric water power energy converters and/or the wind energy plants and/or the hydrodynamically acting auxiliary elements may be set up so as to change their position. When the elements can assume changeable positions, this creates the possibility of influencing, in a targeted manner, the current conditions at the water power energy converters. To the extent that the water power energy converters are wave energy plants, there is in addition the possibility of influencing the wave height by changing the positions of the water power energy converters relative to the other elements of the offshore system in such a way that wave interference patterns have a favorable effect on the wave energies present at the water power energy converters, or reduce the loading for example of the structure of the wind energy plants. In particular, a targeted deactivation and/or a defocusing or focusing of the auxiliary elements can also take place, so that there results an advantageous effect on the wave energies present at the water power energy converters, i.e. the converted energy assumes a maximum, or the loading for example of the structure of the wind energy plants is reduced. A change in the positions of the elements of the offshore system (these elements being understood as the electrical water power energy converters, the wind energy plants, and the hydrodynamically acting auxiliary elements) can also be brought about by the effects of force relative to anchor points in the ocean floor, and/or by the thrust of water force. For example, cable pull systems can be provided between the elements for an exact and permanent modification of their position relative to one another, and the cables can be shortened or lengthened as needed by winches driven by electric motors.

The wind energy plants and/or the hydrodynamically acting auxiliary elements and/or the water power energy converters may be set up to modify their hydrodynamic properties. The hydrodynamic properties of the wind energy plants can for example be modified by static wings and/or flaps on the (submarine) regions of the tower segments and/or foundation parts situated beneath the surface of the water. The hydrodynamic characteristics of the hydrodynamically acting auxiliary elements can likewise be modified by flaps and/or wings, and the orientation of the hydrodynamically acting auxiliary elements as a whole may also be so modified. If the hydrodynamically acting auxiliary elements are situated close to the water power energy converters, they can produce artificial shallows via which on the one hand there can arise increased current speeds of the ocean water, and on the other hand increased swells. Hydraulic and electromotoric actuators are in particular suitable actuators for changing the hydrodynamic characteristics. The hydrodynamic characteristics of the water power energy converters can for example be modified by modifying the wing position, joint position, and/or flap position of the rotors and/or stators, or also by switching off, braking to a standstill, or idling.

According to a further exemplary embodiment of the present invention, the wind energy plants and/or the electric water power energy converters and/or the hydrodynamically acting auxiliary elements can have floating bearing. Such a floating bearing is based essentially on known floating bodies, or so-called pontoons. These ensure on the one hand a flexible configuration of the offshore system as a whole, and in particular also a high degree of flexibility for modifying the positions as well as the distances of the elements of the offshore system relative to one another.

The electrical water power energy converters and the wind energy plants may be situated relative to one another such that the ocean waves impinging on the electrical water power energy converters are superposed either constructively or destructively, such that in the case of small swells the electrical water power energy converters are able to provide a higher level of electrical energy, whereas in the case of particularly large swells, for example due to a storm, at the locations of the wind energy plants a smaller swell loads the structure of the wind energy plants; in other words, the wind energy plants are protected.

Alternatively, the electrical water power energy converters and the hydrodynamically acting auxiliary elements can be situated relative to one another such that the ocean waves impinging on the electrical water power energy converters are constructively superposed and/or the waves impinging on the wind energy plants are destructively superposed. For the case in which both wind energy plants and hydrodynamically acting elements are provided in the offshore system, the spatial disposition of all three element types can be selected so as to correspond to an advantageous pattern of interference of the ocean waves.

It is to be noted that the hydrodynamically acting auxiliary elements do not necessarily have to be separate devices, but rather can also be provided as integrated elements in the submarine regions of the wind energy plants.

According to a further exemplary embodiment of the present invention, the offshore system includes further sensors for acquiring characteristics of the seawater such as ocean current and/or wave characteristics, e.g. wavelength, wave height, wave speed. The sensors can be situated both on the elements of the offshore system and also between them in the area of the offshore system. The sensors can be provided for the acquisition of various measurement quantities, such as the (water) pressure at various points of the undersea structures, as well as force effects, moments, accelerations, deflections (oscillation amplitudes and shapes) on the surfaces and in the structures of the elements, resulting in particular from alternating (water) pressures. From these quantities, for example a hazardous operating situation can be recognized and a targeted controlling of the elements of the offshore system can take place as a countermeasure. In addition, the exemplary embodiment includes a control device for evaluating the sensor signals as well as the electrical power levels emitted by the water power energy converters. The sensors can be connected to the control device either by wires or wirelessly. The electrical power levels emitted by the water power energy converters can for example be forwarded directly to the control device by signaling devices provided on the electric generators. This signaling can also take place either via wires or wirelessly. The control device is further set up to evaluate the sensor signals as well as the electrical power levels emitted by the water power energy converters, and to correspondingly control the electric water power energy converters and/or the electric wind energy plants and/or the hydrodynamically acting auxiliary elements. Thus, the control device can ensure that a changed operational state of the elements of the offshore system, due for example to a changing ocean wave pattern, can be used as a trigger for the modification of the hydrodynamic characteristics of the elements of the offshore system. The positions of the elements of the offshore system can also be modified in response to a changed operational state of these elements and/or a changed ocean wave pattern.

According to a further aspect of the exemplary embodiments and/or exemplary methods of the present invention, a method is provided for operating an offshore system, having the features described herein. The method includes the step of acquiring the electrical power levels emitted by the electrical water power energy converters. Acquisition of further measurement quantities can also be provided, such as the (water) pressure at various points of the undersea structures, as well as force effects, moments, accelerations, deflections (oscillation amplitudes and shapes) on the surfaces and in the structures of the elements, resulting in particular from alternating (water) pressures. From these quantities, for example a hazardous operating situation can be recognized and a targeted controlling of the elements of the offshore system can take place as a countermeasure. In addition, the method includes the step of determining a change in the electrical power levels emitted by the electrical water power energy converters over time. In response to this, the electrical water power energy converters and/or the electrical wind energy plants and/or the hydrodynamically acting auxiliary elements are controlled so as to increase the emitted electrical power levels.

According to a further aspect of the exemplary embodiments and/or exemplary methods of the present invention, the method further includes the acquisition of characteristics of the seawater, such as the current and/or the wave properties. In response to a changed ocean wavelength and/or ocean current, the distance of the electrical water power energy converters and/or of the electrical wind energy plants and/or of the hydrodynamically acting auxiliary elements from one another is optimized. This can for example take place in that a greatly increased ocean current and/or a greatly increased wave formation is recognized as a storm, and on the one hand the hydrodynamic characteristics of the elements of the offshore system are modified such that as little energy as possible acts on the elements themselves, while on the other hand the elements influence the ocean current and/or wave formation in such a way that as little energy as possible impinges on other elements of the offshore system. On the other hand, the distance between the elements of the offshore system can be optimized so that in the case of low ocean current and/or low wave formation an increased amount of energy acts on the electrical energy generating units (water power energy converters). In particular, the optimization of the distance between the elements of the offshore system with regard to the wave pattern can take place in accordance with known laws of wave interference, through diffraction and/or reflection at a grid or at a gap.

A further aspect of the exemplary embodiments and/or exemplary methods of the present invention relate to a computer program code, containing program code that when executed on a processor causes the processor to carry out the above-named method for operating an offshore system. The computer program product can exist either on a storage medium (CD, USB memory stick, or the like) or as a signal sequence.

In the following, exemplary embodiments of the present invention are described in detail with reference to the accompanying drawings.

### BRIEF DESCRIPTION OF THE DRAWINGS

FIG. 1 shows a top view of an offshore system according to the present invention having water power energy converters and wind energy plants, and current conditions developing in the vicinity thereof.

FIG. 2 shows a part of a system according to the present invention made up of a hydrodynamically acting auxiliary element and an electrical water power energy converter.

FIG. 3 shows a part of a system according to the present invention of a current energy converter and an electrical water power energy converter.

FIG. 4 shows a part of a system according to the present invention including hydrodynamically acting auxiliary elements and an electrical water power energy converter.

FIG. 5 shows a schematic top view of a system of wind energy plants, electrical water power energy converters, and an adaptation device according to a further exemplary embodiment of the present invention.

FIG. 6 shows a flow diagram illustrating the steps of the method according to the present invention for operating an offshore system.

### DETAILED DESCRIPTION

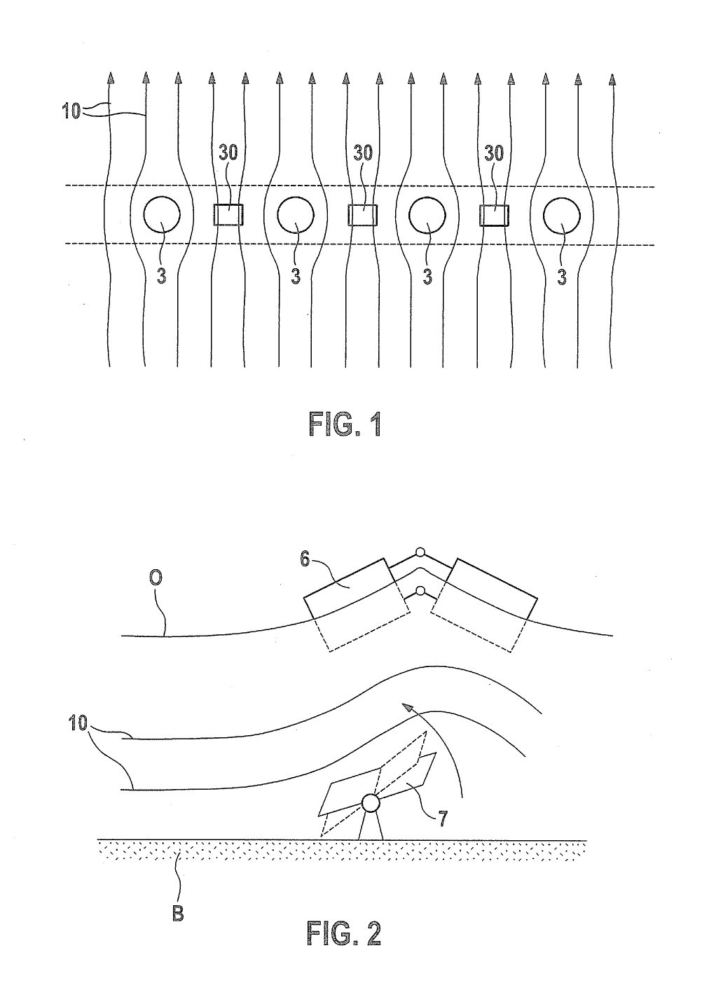

FIG. 1 shows a schematic top view of a system of wind energy plants 3. Wind energy plants 3 are configured as a so-called offshore wind park, a change of ocean current corresponding to current lines 10 resulting from their submarine tower segments and/or their foundations. In the region emphasized by broken lines near wind energy plants 3, the flow around wind energy plants 3 leads to increased current speeds, illustrated by crowding of current lines 10. The foundations of wind energy plants 3 act here as hydrodynamically acting auxiliary elements that have a targeted influence on ocean waves and/or ocean currents. In the region emphasized by broken lines, the water thus has a higher specific kinetic energy, for which reason this region may be used as a location for the situation of water power energy converters 30, e.g. tidal power stations, current energy converters, and the like. In addition, when wind energy plants 3 and electric water power energy converters 30 are connected to the electrical network, the advantage results that the average cable length between the elements is shorter, so that costs are saved.

FIG. 2 shows a wave energy converter 6 on ocean surface O. Underneath wave energy converter 6, an adjustable element 7 is situated on seafloor B as a hydrodynamically acting auxiliary element. Adjustable element 7 is essentially made up of a pivotably mounted plate that can be set against the ocean current corresponding to the depicted arrow direction, forming depicted current lines 10. In other words, adjustable element 7 is an artificial shallow area for the ocean current, causing higher waves to form above adjustable element 7 that provide wave energy converter 6 with more energy. Adjustable element 7 can for example be set against the current using electrical actuators, but does not itself add any kinetic energy to the ocean water or ocean current. Its action is limited to transforming existing energy in the ocean water into an energy form that can be converted into electrical energy by a separately provided electrical water power energy converter. In the depicted configuration, adjustable element 7 provides a higher average wave height at the location of wave energy converter 6.

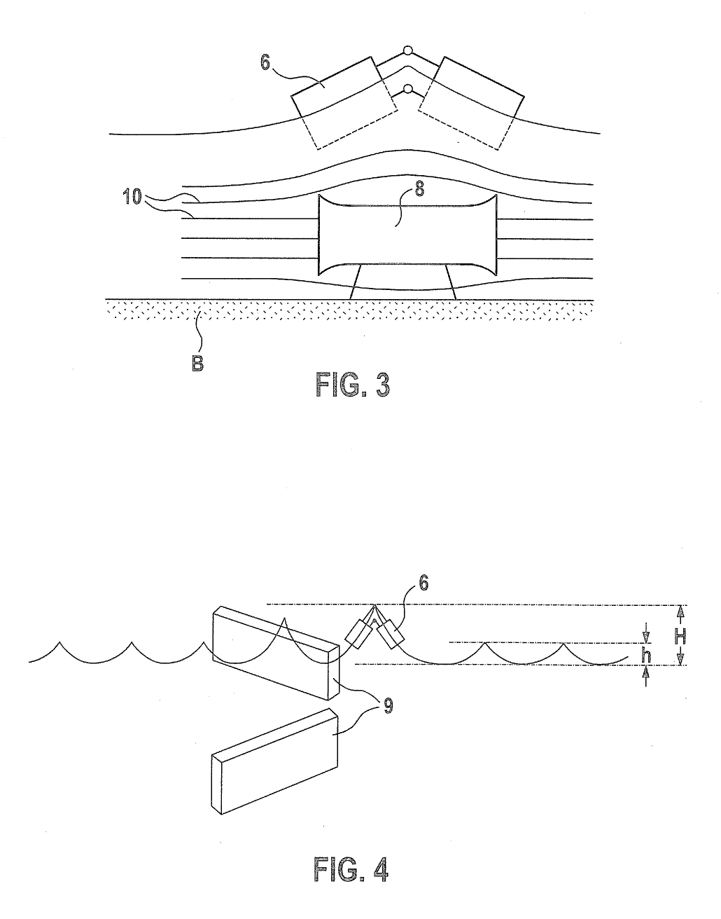

FIG. 3 shows a configuration that is modified relative to FIG. 2, in that adjustable element 7 has been replaced by a current energy converter 8. Current energy converter 8 is attached to the ocean floor and converts ocean current into electrical energy using a turbine, in the manner of a tidal power station. In addition, the situation of current energy converter 8 underneath wave energy converter 6 however also represents an artificial shallow area in the ocean, which, in a known manner, influences the swell and locally increases the average wave height. In this way, depicted wave energy converter 6 can produce an increased amount of electrical energy from the force of the waves.

FIG. 4 shows a perspective view of a configuration of passive elements 9 that, as hydrodynamically acting auxiliary elements 4, provide an increased swell at the location of a wave energy converter 6. The two depicted passive elements 9 are made up of walls that run toward one another (toward the right in the drawing). Through this configuration, wave energy and current energy are concentrated at the location of wave energy converter 6, so that this converter can convert more electrical energy from water force. Shown in broken lines is the height of average wave peaks h as they would be present at the location of wave energy converter 6 in the absence of passive elements 9. In contrast, shown in dash-dotted lines is the height of modified wave peaks H due to the presence of passive elements 9. An advantage of the depicted configuration is therefore that passive elements 9, which are largely maintenance-free, significantly improve the energetic yield of a wave energy converter 6.

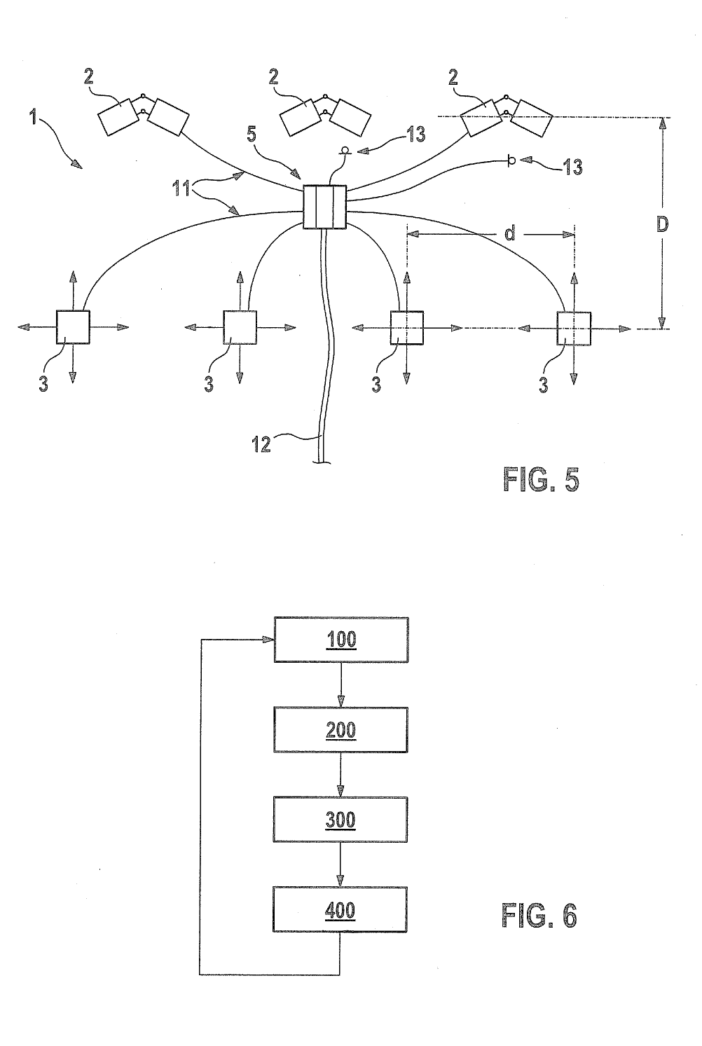

FIG. 5 shows a schematic configuration of wind energy plants 3 and electrical water power energy converters 2 of an offshore system 1, in a top view. Arrows indicate that wind energy plants 3 have floating bearing, and that their positions can be modified both relative to one another and also relative to the depicted electrical water power energy converters 2. An adaptation device 5 is provided for collecting, via energy lines 11, the electrical power produced in electrical water power energy converters 2 and in wind energy plants 3, combining this electrical energy, and conducting it to a connected energy network (not shown) via a landline 12. Adaptation device 5 can, in the simplest case, be an electrical node point, but however can also include electrical energy converters, such as frequency converters and transformers, in order to first make possible a combination of different forms of electrical energy. In addition, an electrochemical energy converter is to be provided in the housing of adaptation device 5. This converter includes a hydrolysis device having a connected liquefaction and storage device. Via a pipeline, as landline 12, the fluids are supplied to further processing or to the consumer. Alternatively or in addition, provided energy storage devices connected to adaptation device 5 can be emptied at regular intervals by transport ships, and the energy can be supplied to the consumer in the form of fuel or chemically stored electrical energy (accumulators).

For the targeted adaptation of distance d of wind energy plants 3 from one another, and of distance D of wind energy plants 3 from electrical water power energy converters 2, further sensors 13 are provided that record the wave pattern in the region of offshore system 1. Sensors 13 are connected by signal lines to a control device (not shown separately) in the housing of adaptation device 5. Sensors 13 determine the energy and the frequency and the average wavelength of the swell prevailing in the region of the offshore system, and send corresponding signals to the control device, which evaluates the sensor signals and determines changes over time. The electrical power levels of wind energy plants 3 and of electrical water power energy converters 2 are also provided to the control device as further input quantities. From these as well, the control device determines possible deviations in the power balance of the elements over time. If, in response to a changed average wavelength, the electrical power output of electrical water power energy converters 2 decreases, the control device causes the elements of offshore system 1 to change their positions. Here, the control device can modify both distance d of the wind energy plants from one another and also distance D of wind energy plants 3 from electrical water power energy converters 2. A change in the distance of the elements from one another causes a change in the interference pattern of the overall wave pattern, and can thus be set in a targeted manner in order to supply more wave energy to electrical water power energy converters 2.

In the case of strongly excessive wave occurrence, for example during a storm, the positions of wind energy plants 3 and/or the positions of water power energy converters 2 can be changed in such a way that electrical water power energy converters 2 provide an interference pattern in which wind energy plants 3 are each situated in a region in which the interference pattern has low average wave heights. In this way, wind energy plants 3 are protected from storm damage.

FIG. 6 shows a flow diagram with the steps of the method according to the present invention for operating an offshore system 1. In step 100, measurement quantities of the swell are acquired by sensors 13, and measurement quantities are determined for the electrical power levels produced in electrical water power energy converters 2.

In step 200, a comparison of the acquired measurement quantities with previously stored measurement quantities is carried out, and from this it is determined whether an adaptation of the actuating quantities for wind energy plants 3, electrical water power energy converters 2, and hydrodynamically acting auxiliary elements 4 would have a positive influence on the energy yield at electrical water power energy converters 2. For this purpose, in step 200 data sets stored in a storage device, representing the interference patterns of the ocean waves that are to be expected as a function of the wavelength and of distance d and distance D, can be retrieved. Likewise, threshold values can be retrieved for the classification of a weather situation as a storm, or in general as an abnormal operating state, and can be compared with the measured measurement quantities.

In step 300, the determination of parameters takes place for the adaptation of the elements of offshore system 1 in order to optimize the operational behavior. Based on comparison 200, required actuating quantities are determined on the basis of which hydrodynamically acting auxiliary elements 4, wind energy plants 3, and electrical water power energy converters 2 are situated relative to one another and/or modified in their hydrodynamic characteristics.

In step 400, the elements of offshore system 1 are adapted on the basis of the parameter determination that took place in step 300. Via actuators (for example cable pulls), the hydrodynamic characteristics of the elements and/or their distance from one another are adapted, thus modifying the wave interference pattern. For the case in which the thus modified configuration of offshore system 1 produces more energy than before, this is recognized anew in step 100, in the course of a subsequent acquisition of measurement quantities.

It is to be noted that the method according to the present invention can be executed as a self-learning process, in that a microprocessor checks the comparison values of temporally successively acquired measurement quantities with the parameters thereupon determined for the modification of the configuration of offshore system 1, and stores parameter sets of successful regulating processes in a data storage device. For the case in which a change in the acquired measurement quantities was already successfully corrected at an earlier time by the system, in step 300 values retrieved from the storage device can be used as a starting point, or for the plausibilization of a newly carried out parameter determination.

The above-named exemplary embodiments are provided only for the purpose of illustration. The illustrated features of the present invention can of course be exchanged between the depicted exemplary embodiments, and/or can be used to supplement one another. The range of protection of the present invention, as defined exclusively by the accompanying descriptions, is not limited by the discussed exemplary embodiments.

What is claimed is:

1. An offshore system for producing regenerative energy, comprising:
a system of electrical water power energy converters;
a system of wind energy plants; and
a system of hydrodynamically acting auxiliary elements;
wherein the hydrodynamically acting auxiliary elements are set up to influence, in a targeted manner, at least one of ocean waves and ocean currents with regard to their energy at the positions of at least one of the electrical water power energy converters and the wind energy plants, through interference.

2. The offshore system of claim 1, further comprising:
an adaptation device for receiving the electrical energy from the electrical water power energy converters and the wind energy plants, the adaptation device being set up to convert the energy and to remove the energy from the offshore system.

3. The offshore system of claim 1, wherein at least one of the electrical water power energy converters, the wind energy plants, and the hydrodynamically acting auxiliary elements is set up to change their positions.

4. The offshore of claim 1, submarine regions of at least one of the wind energy plants, the hydrodynamically acting auxiliary elements, and the water power energy converters is set up to modify their hydrodynamic characteristics.

5. The offshore system of claim 1, wherein at least one of the wind energy plants, the electrical water power energy converters, and the hydrodynamically acting auxiliary elements have floating bearings.

6. The offshore system of claim 1, wherein at least one of the electrical water power energy converters, the wind energy plants, and the hydrodynamically acting auxiliary elements is situated relative to one another such that at least one of the following is satisfied: (i) ocean waves impinging on the electrical water power energy converters are constructively superposed, and (ii) ocean waves impinging on the wind energy plants are destructively superposed.

7. The offshore system of claim 1, further comprising:
sensors for acquiring characteristics of the seawater; and
a control device that is configured for the evaluation of the sensor signals and of the electrical power levels emitted by the water power energy converters, and for the controlling of at least one of the electrical water power energy converters, the electrical wind energy plants, and the hydrodynamically acting auxiliary elements.

8. A method for operating an offshore system, the method comprising:
acquiring electrical power levels emitted by electrical water power energy converters;
determining a change in the electrical power levels emitted by the electrical water power energy converters over time; and
controlling at least one of the electrical water energy converters, electrical wind energy plants, and hydrodynamically acting auxiliary elements to modify the emitted electrical power levels, to increase them;
wherein the offshore system for producing regenerative energy, includes:
a system of the electrical water power energy converters;
a system of the wind energy plants; and
a system of the hydrodynamically acting auxiliary elements, the hydrodynamically acting auxiliary elements being set up to influence, in a targeted manner, at least one of ocean waves and ocean currents with regard to their energy at the positions of at least one of the electrical water power energy converters and the wind energy plants, through interference.

9. The method of claim 8, the method further comprising:
acquiring characteristics of the seawater; and
in response to at least one of a changed ocean wavelength and an ocean current, optimizing the distance of at least one of the electrical water power energy converters, the electrical wind energy plants, and the hydrodynamically acting auxiliary elements from one another.

10. A computer readable medium having a computer program, which is a executable by a processor, comprising:
a program code arrangement having program code for operating an offshore system, by performing the following:
acquiring electrical power levels emitted by electrical water power energy converters;
determining a change in the electrical power levels emitted by the electrical water power energy converters over time; and
controlling at least one of the electrical water energy converters, electrical wind energy plants, and hydrodynamically acting auxiliary elements to modify the emitted electrical power levels, to increase them;
wherein the offshore system for producing regenerative energy, includes:
a system of the electrical water power energy converters;
a system of the wind energy plants; and
a system of the hydrodynamically acting auxiliary elements, the hydrodynamically acting auxiliary elements being set up to influence, in a targeted manner, at least one of ocean waves and ocean currents with regard to their energy at the positions of at least one of the electrical water power energy converters and the wind energy plants, through interference.
